(19) United States
(12) Patent Application Publication
(10) Pub. No.: US 2015/0253977 A1
(43) Pub. Date: Sep. 10, 2015

(54) MEDICAL IMAGING APPARATUS FOR PROVIDING GUIDE INFORMATION AND METHOD OF PROVIDING GUIDE INFORMATION

(71) Applicant: SAMSUNG MEDISON CO., LTD., Hongcheon-gun (KR)

(72) Inventor: Dae-woong KANG, Hongcheon-gun (KR)

(21) Appl. No.: 14/533,880

(22) Filed: Nov. 5, 2014

(30) Foreign Application Priority Data
Mar. 7, 2014 (KR) 10-2014-0027430

(51) Int. Cl. G06F 3/0484; H04W 4/00; G06F 3/0481

(52) U.S. Cl. CPC G06F 3/04847; G06F 3/0481; H04W 4/008

(57) ABSTRACT

Provided are medical imaging method and apparatus for providing guide information, which allow a user to easily use the guide information provided by the medical imaging apparatus. A method of providing guide information in a medical imaging system includes: transmitting, by the external device, a request for a guide to the medical imaging apparatus; determining, by the medical imaging apparatus, guide information corresponding to the request for the guide; transmitting, by the medical imaging apparatus, the determined guide information to the external device; and displaying the guide information by the external device.

### RELATED APPLICATION

This application claims the benefit of Korean Patent Application No. 10-2014-0027430, filed on Mar. 7, 2014, in the Korean Intellectual Property Office, the disclosure of which is incorporated herein in its entirety by reference.

### BACKGROUND

1. Field

One or more embodiments of the present invention relate to a medical imaging apparatus for providing guide information and a method of providing guide information, and more particularly, to a medical imaging method and apparatus for providing guide information, which allow a user to easily use the guide information provided by the medical imaging apparatus.

2. Description of the Related Art

Various types of medical imaging devices are used to observe the internal structures of a human body and diagnose diseases. Examples of medical imaging devices may include an ultrasound diagnostic device, a computed tomography (CT) device, a magnetic resonance imaging (MRI) device, a positron emission tomography (PET) device, and an X-ray system.

In general, a medical imaging device may display guide information such as a manipulation method so that a user can easily use the medical imaging device. However, if guide information is displayed on a display unit in the medical imaging apparatus, the guide information may cause inconvenience to users by hiding at least a region of a screen.

### SUMMARY

One or more embodiments of the present invention include a method and a medical imaging apparatus for providing guide information, which allow a user to easily use the guide information provided by the medical imaging apparatus.

Additional aspects will be set forth in part in the description which follows and, in part, will be apparent from the description, or may be learned by practice of the presented embodiments.

According to one or more embodiments of the present invention, a method of providing guide information in a medical imaging system including a medical imaging apparatus and an external device includes: transmitting, by the external device, a request for a guide to the medical imaging apparatus; determining, by the medical imaging apparatus, guide information corresponding to the request for the guide; transmitting, by the medical imaging apparatus, the determined guide information to the external device; and displaying the guide information by the external device.

In the determining of the guide information, the medical imaging apparatus may determine the guide information according to an operation state thereof.

The determining of the guide information may further include performing image recognition on a screen displayed on the medical imaging apparatus, wherein the performing is performed by the medical imaging apparatus, and determining the operation state based on the result of the image recognition, wherein the determining is performed by the medical imaging apparatus.

The operation state may include an operation mode of the medical imaging apparatus.

The determining of the guide information may include: retrieving, by the medical imaging apparatus, a document related to the operation state; and determining, by the medical imaging apparatus, the guide information containing information related to the retrieved document.

The medical imaging apparatus and the external device may communicate with each other by using short-range wireless communication.

The guide information may include address information, and the displaying of the guide information may include: receiving data, by the external device, based on the address information and displaying, by the external device, the received data.

According to one or more embodiments of the present invention, a method of providing guide information in a medical imaging apparatus includes: receiving a request for a guide from an external device; determining guide information corresponding to the request for the guide; and transmitting the determined guide information to the external device.

In the determining of the guide information, the guide information may be determined according to an operation state of the medical imaging apparatus.

The determining of the guide information may further include: performing image recognition on a screen displayed on the medical imaging apparatus; and determining the operation state based on the result of the image recognition.

The operation state may include an operation mode of the medical imaging apparatus.

The guide information may include a reference medical image corresponding to the operation state.

The determining of the guide information may include retrieving a document related to the operation state and determining the guide information containing information related to the retrieved document.

The medical imaging apparatus may communicate with the external device by using short-range wireless communication.

The guide information may include address information necessary for receiving data.

According to one or more embodiments of the present invention, a medical imaging apparatus includes a communication unit that performs communication with an external device; and a controller that, upon receipt of a request for a guide from the external device, determines guide information corresponding to the request for the guide, and controls the operation of the communication unit so that the determined guide information is transmitted to the external device through the communication unit.

The controller may determine the guide information according to an operation state of the medical imaging apparatus.

The controller may perform image recognition on a screen displayed on the medical imaging apparatus and determines the operation state based on the result of the image recognition.

The operation state may include an operation mode of the medical imaging apparatus.

The guide information may include a reference medical image corresponding to the operation state.

The controller may retrieve a document related to the operation state, and the guide information may include information related to the retrieved document.

The communication unit may perform communication with the external device by using wireless local area communication.

The guide information may include address information necessary for receiving data.

According to one or more embodiments of the present invention, a medical imaging system includes a medical imaging apparatus that receives a request for a guide from an external device, determines guide information corresponding to the received request for the guide, and transmits the guide information to the external device; and the external device that transmits the request for the guide to the medical imaging apparatus and displays the guide information received from the medical imaging apparatus.

According to one or more embodiments of the present invention, a non-transitory computer-readable recording medium has recorded thereon a program for executing the above-described methods on a computer.

### BRIEF DESCRIPTION OF THE DRAWINGS

These and/or other aspects will become apparent and more readily appreciated from the following description of the embodiments, taken in conjunction with the accompanying drawings in which:

FIG. 1 is a conceptual diagram of a medical imaging system according to an exemplary embodiment of the present invention;

FIG. 2 is a flowchart of a process of providing guide information in a medical imaging system, according to an exemplary embodiment of the present invention;

FIG. 3 is a conceptual diagram of a method of receiving a user's input in an external device according to an exemplary embodiment of the present invention;

FIG. 4 is a conceptual diagram of a screen displayed on a display unit in a medical imaging system according to an exemplary embodiment of the present invention;

FIG. 5 is a conceptual diagram of an external device that displays guide information according to an exemplary embodiment of the present invention;

FIG. 6 is a flowchart of a process of providing guide information in a medical imaging apparatus according to an exemplary embodiment of the present invention;

FIG. 7 is a flowchart of a process of displaying guide information in an external device according to an exemplary embodiment of the present invention;

FIG. 8 is a block diagram of a configuration of a medical imaging apparatus according to an exemplary embodiment of the present invention;

FIG. 9 is a schematic diagram of a configuration of a medical imaging apparatus according to an exemplary embodiment of the present invention; and

FIG. 10 is a block diagram of a configuration of an external device according to an exemplary embodiment of the present invention.

### DETAILED DESCRIPTION

Exemplary embodiments of the present invention will now be described more fully hereinafter with reference to the accompanying drawings so that they may be easily implemented by one of ordinary skill in the art. However, the present embodiments may have different forms and should not be construed as being limited to the descriptions set forth herein. In addition, parts not related to the present invention are omitted to clarify the description of exemplary embodiments of the present invention. In the accompanying drawings, like reference numerals refer to like elements throughout.

Throughout the specification, it will be understood that when an element is referred to as being “connected” or “coupled” to another element, it can be directly connected to or electrically coupled to the other element with one or more intervening elements interposed therebetween. Furthermore, when an element is referred to as being connected or coupled to another element for communication, the elements can perform communication with each other. Expressions such as “at least one of,” when preceding a list of elements, modify the entire list of elements and do not modify the individual elements of the list.

Throughout the specification, it will also be understood that when a part “includes” or “comprises” an element, unless there is a particular description contrary thereto, the part can further include other elements, not excluding the other elements. In addition, terms such as “ . . . unit”, “ . . . module”, or the like refer to units that perform at least one function or operation, and the units may be implemented as hardware or software or as a combination of hardware and software.

In the specification, a “medical imaging apparatus” is an ultrasound diagnostic device, but it is not limited thereto. Examples of the medical imaging apparatus may include a computed tomography (CT) device, a magnetic resonance imaging (MRI) device, a positron emission tomography (PET) device, and an X-ray system.

Throughout the specification, an “ultrasonic image” refers to an image of an object obtained using an ultrasonic wave. Furthermore, in the present specification, an “object” may include a person or an animal, or a part of a person or an animal. For example, the object may include organs such as the liver, the heart, the womb, the brain, a breast, and the abdomen, or a blood vessel. Furthermore, the “object” may include a phantom. The phantom may comprise a material having a volume that approximates the density and effective atomic number of a living organism.

Furthermore, in the present specification, a “user” refers to a medical professional, such as a doctor, a nurse, a medical laboratory technologist, and a medical imaging expert, and a technician who repairs a medical apparatus, but the user is not limited thereto.

In addition, throughout the specification, an “external device” is referred to as including a touch screen, but may include an input or output device other than the touch screen. The external device may include a mobile phone, a smartphone, a tablet PC, a personal digital assistant (PDA), a notebook (laptop), or a connected TV, but is not limited thereto.

The embodiments of the present invention will now be described in detail with reference to the accompanying drawings.

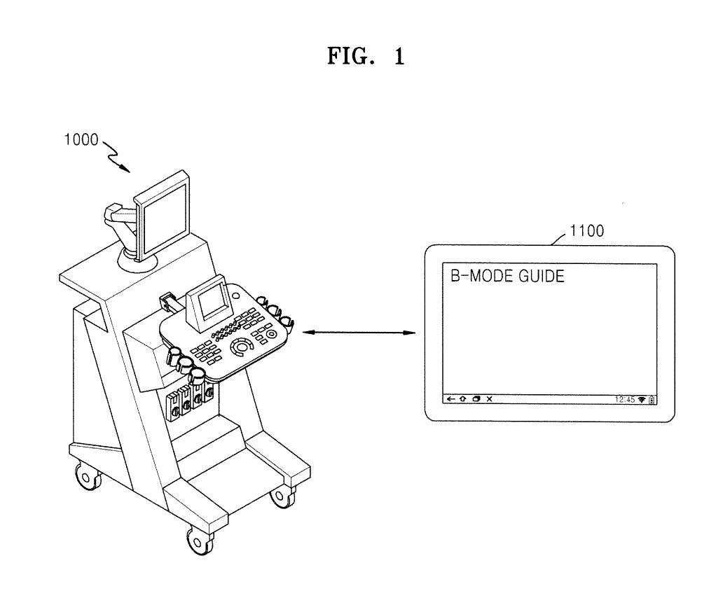

FIG. 1 is a conceptual diagram of a medical imaging system according to an exemplary embodiment of the present invention. Referring to FIG. 1, the medical imaging system according to the present embodiment may include a medical imaging apparatus 1000 and an external device 1100.

The medical imaging apparatus 1000 is configured to acquire and display a medical image of an object through a user's manipulation. For example, the medical imaging apparatus 1000 may include at least one of an ultrasound diagnostic device, a CT device, an MRI device, a PET device, and an X-ray system.

The external device 1100 is configured to display information. In one embodiment, the external device 1100 may perform wired or wireless communication with the medical imaging apparatus 1000. For example, the external device 1100 may perform wired or wireless communication with the medical imaging apparatus 1000. The external device 1100 may be connected to the medical imaging apparatus 1000 for communication by using a short-range wireless communication technology such as Bluetooth™, Wi-Fi, or Near Field Communication (NFC).

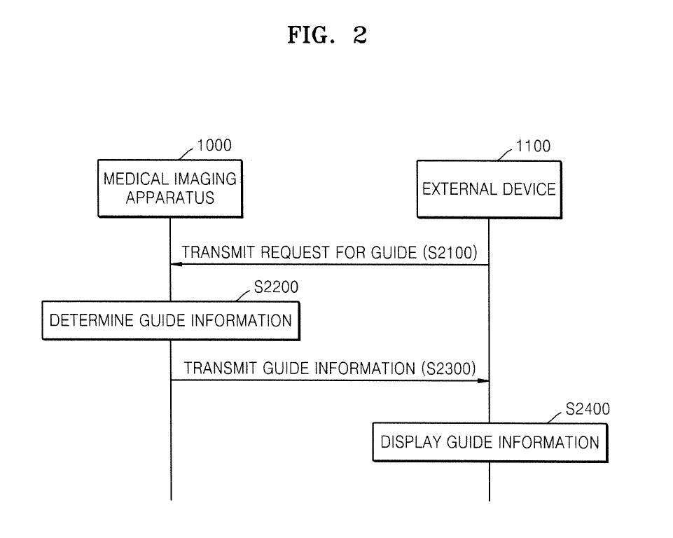

FIG. 2 is a flowchart of a process of providing guide information in a medical imaging system according to an exemplary embodiment of the present invention.

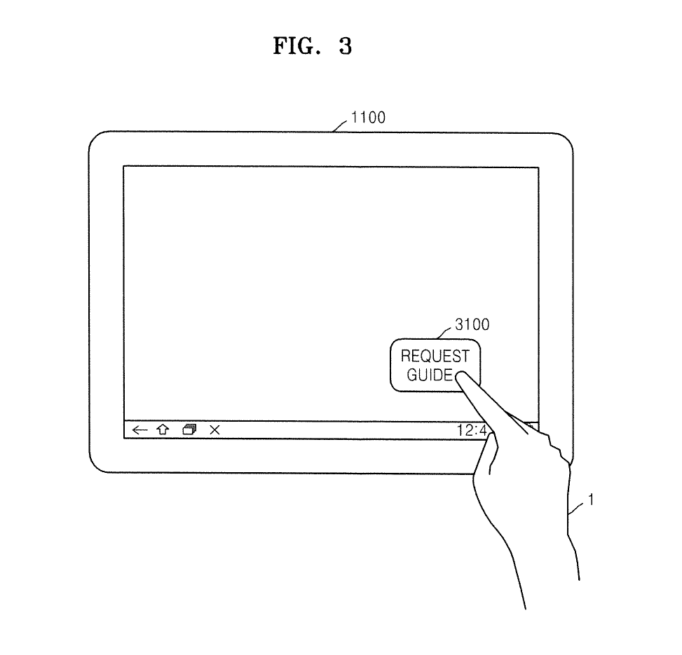

Referring to FIG. 1, first, an external device 1100 may transmit a request for a guide to a medical imaging apparatus 1000 (S2100). In this case, the external device 1100 may execute an application installed on the external device 1100 for providing a guide (hereinafter referred to as a “guide provision application”). The guide provision application may be used to display guide information. The external device 1100 may receive a user's input by using the guide provision application. FIG. 3 is a conceptual diagram of a method of receiving a user's input in the external device 1100 according to an exemplary embodiment of the present invention. Referring to FIG. 3, the external device 1100 may provide a user interface 3100 for receiving an input from a user 1. For example, if the external device 1100 includes a touch screen, a button may be displayed on the touch screen as the user interface.

Thereafter, the medical imaging apparatus 1000 may determine guide information corresponding to the received request for the guide (S2200). According to an embodiment, the medical imaging apparatus 1000 may determine guide information according to an operation state thereof. The operation state of the medical imaging apparatus 1000 means a state of an operation performed by the medical imaging apparatus 1000 according to a user's manipulation. For example, if the medical imaging apparatus 1000 displays a brightness (B)-mode image for ultrasound diagnosis, the state in which the B-mode image is displayed may be the operation state of the medical imaging apparatus 1000. Furthermore, the operation state of the medical imaging apparatus 1000 may include an operation mode set for the medical imaging apparatus 1000. The operation mode may refer to a setting of a way in which the medical imaging apparatus 1000 operates, such as a B-mode or a C-mode.

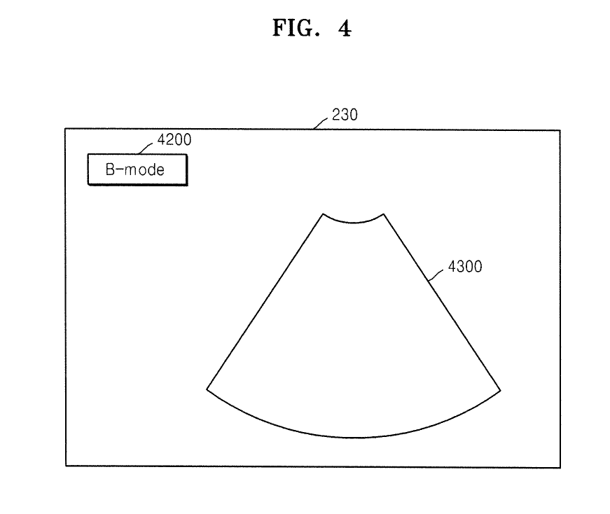

In some embodiments, the medical imaging apparatus 1000 may perform image recognition on a screen being displayed on the medical imaging apparatus 1000 in order to determine an operation state thereof. In other words, the medical imaging apparatus 1000 may determine the operation state of the medical imaging apparatus 1000 according to the type of an image being displayed thereon. FIG. 4 illustrates an example where a B-mode image 4300 is displayed on a screen of a display unit 230 in the medical imaging apparatus 1000. Referring to FIG. 4, when the B-mode image 4300 is displayed on the display unit 230, a text 4200 may be displayed together thereon to inform that the B-mode image 4300 is being displayed. Thus, the medical imaging apparatus 1000 may determine an operation state of the medical imaging apparatus 1000 in which the B-mode image 4300 is displayed, based on the text 4200 displayed on the screen of the display unit 230. However, this method is provided to describe some embodiments, and image recognition may be performed in various other ways. For example, the medical imaging apparatus 1000 may determine an operation state thereof based on the result of image recognition performed on the B-mode image 4300.

Furthermore, in some embodiments, the medical imaging apparatus 1000 may retrieve a document related to an operation state thereof. For example, when the medical imaging apparatus 1000 is in an operation state where a breast ultrasound image is displayed, the medical imaging apparatus 1000 may retrieve a paper related to the breast ultrasound image. The medical imaging apparatus 1000 may then generate guide information containing information related to the retrieved document. The information related to the retrieved document may include address information indicating a location of the document or document file.

The medical imaging apparatus 1000 may then transmit the guide information determined in operation S2200 to the external device 1100 (S2300). According to one embodiment, the guide information transmitted to the external device 1100 may include identification (ID) information necessary for distinguishing the guide information. The ID information may be address information indicating a location of the guide information. For example, the address information may contain a Uniform Resource Locator (URL) for receiving the guide information.

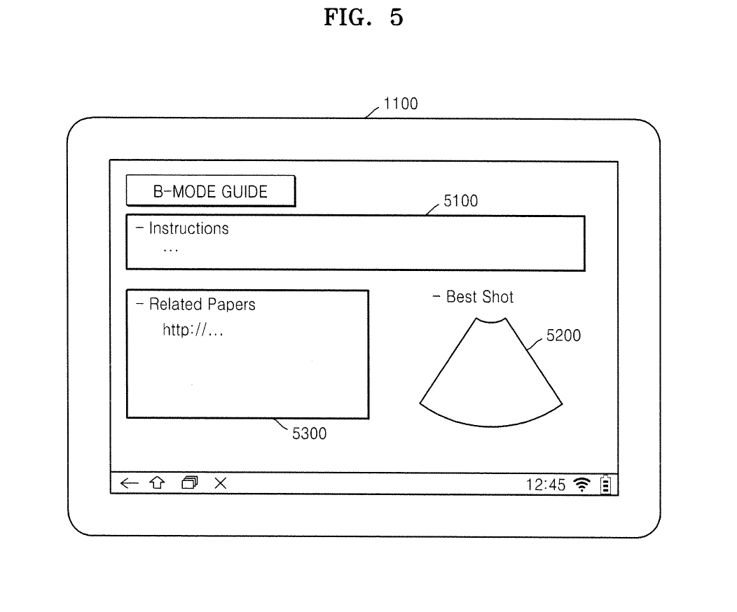

Subsequently, the external device 1100 may display the received guide information (S2400). Referring to FIG. 5, the external device 1100 may display guide information such as a manipulation guide 5100 for the medical imaging apparatus 1000, a reference image 5200, or related papers 5300. The manipulation guide 5100 may include a method of manipulating the medical imaging apparatus 1000 for capturing a medical image. The reference image 5200 may include a medical image used as a reference according to an operation state of the medical imaging apparatus 1000. The user may capture a medical image by referring to the reference image 5200. The external device 1100 may also display information such as a list of URLs for receiving the related papers 5300.

Here, if the guide information received by the external device 1100 from the medical imaging apparatus 1000 includes address information, the external device 1100 may display data that is received based on the address information. For example, if the guide information includes URL information about a related paper, the external device 1100 may receive the related paper based on the URL information and then display the related paper.

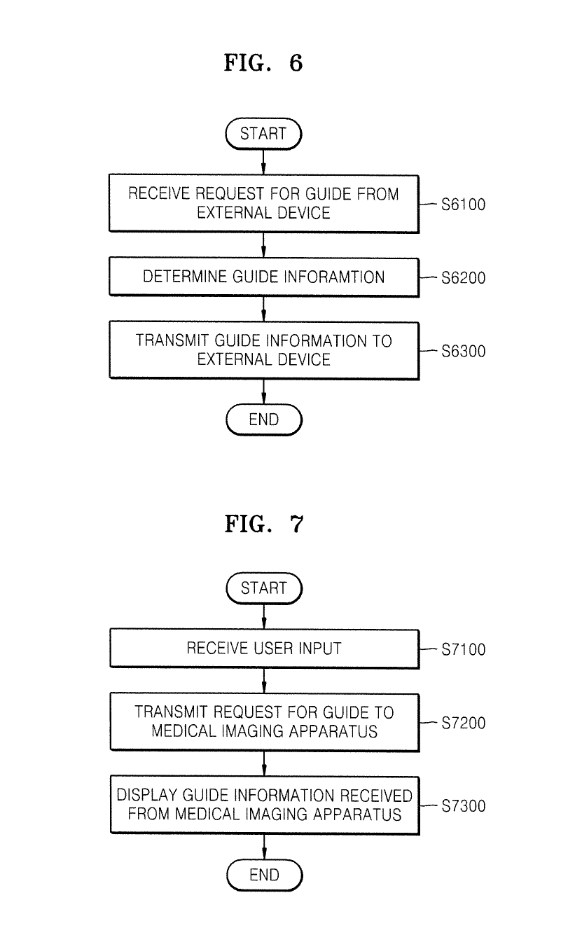

FIG. 6 is a flowchart of a process of providing guide information in the medical imaging apparatus (1000 in FIG. 1) according to an exemplary embodiment of the present invention.

Referring to FIG. 6, the medical imaging apparatus 1000 may receive a request for a guide from the external device (1100 in FIG. 1) (S6100). The medical imaging apparatus 1000 may determine guide information corresponding to th received request for the guide (S6200). According to one embodiment, the medical imaging apparatus 1000 may determine guide information according to an operation state thereof. In some embodiments, the operation state of the medical imaging apparatus 1000 may include an operation mode set for the medical imaging apparatus 1000. Furthermore, the medical imaging apparatus 1000 may perform image recognition on a screen being displayed on the medical imaging apparatus 1000 in order to determine the operation state thereof. In other words, the medical imaging apparatus 1000 may determine the operation state of the medical imaging apparatus 1000 according to the type of an image being displayed thereon. In some embodiments, the medical imaging apparatus 1000 may also retrieve a document related to the operation state thereof. In this case, the medical imaging apparatus 1000 may generate guide information containing information related to the retrieved document.

The medical imaging apparatus 1000 may retrieve a document related to an operation state thereof. For example, when the medical imaging apparatus 1000 is in an operation state where a breast ultrasound image is being displayed, the medical imaging apparatus 1000 may retrieve a paper related to the breast ultrasound image. The medical imaging apparatus 1000 may then generate guide information containing information related to the retrieved document. The information related to the retrieved document may include address information indicating a location of the document or document file.

The medical imaging apparatus 1000 may then transmit the determined guide information to the external device 1100 (S6300). According to one embodiment, the guide information transmitted to the external device 1100 may include ID information necessary for distinguishing the guide information. The ID information may be address information indicating a location of the guide information. For example, the address information may contain a URL for receiving the guide information.

The guide information may include at least one of a manipulation guide, a reference image, and a related document.

FIG. 7 is a flowchart of a process of displaying guide information in the external device (1100 in FIG. 1) according to an exemplary embodiment of the present invention.

The external device 1100 may receive a user input via a user interface (S7100). In this case, the external device 1100 may provide the user interface by using a guide provision application installed on the external device 1100.

When the user input is received in operation S7100, the external device 1100 may transmit a request for a guide to the medical imaging apparatus 1000 (S7200). Upon receipt of guide information from the medical imaging apparatus 1000 in response to the request for the guide, the external device 1100 may display the received guide information (S7300). Referring to FIG. 5, the external device 1100 may display guide information such as the manipulation guide 5100 for the medical imaging apparatus 1000, the reference image 5200, or the related papers 5300. The manipulation guide 5100 may include a method of manipulating the medical imaging apparatus 1000 for capturing a medical image. The reference image 5200 may include a medical image that a user may use as a reference according to an operation state of the medical imaging apparatus 1000. The user may capture a medical image by referring to the reference image 5200. The external device 1100 may display information such as a list of URLs for receiving the related papers 5300.

Here, if the guide information received by the external device 1100 from the medical imaging apparatus 1000 includes address information, the external device 1100 may display data that is received based on the address information. For example, if the guide information includes URL information about a related paper, the external device 1100 may receive the related paper based on the URL information and then display the related paper.

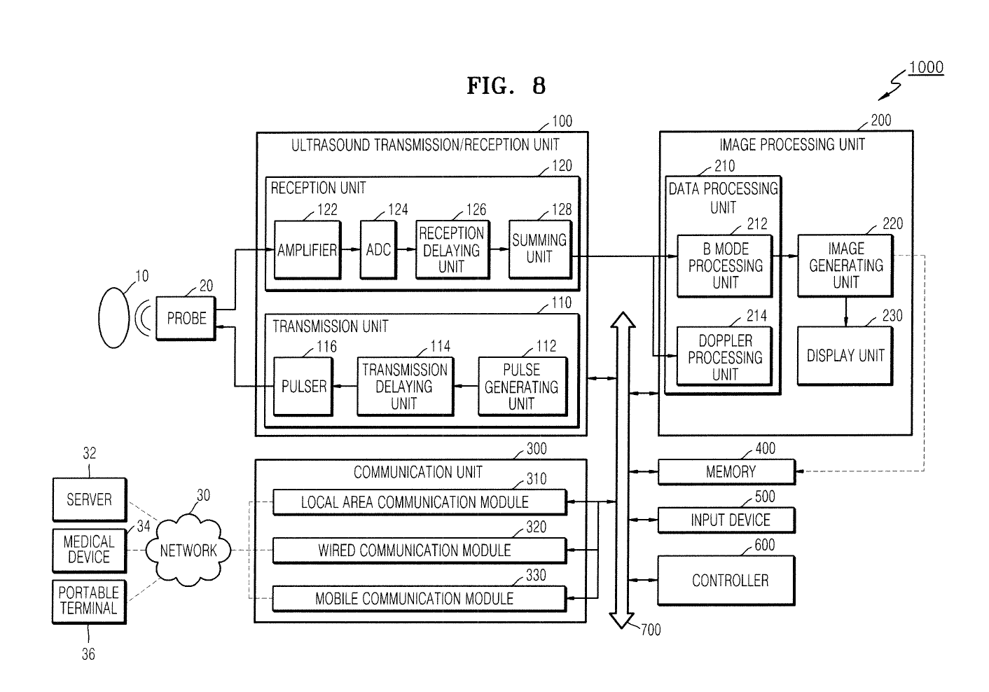

In one embodiment, a medical imaging apparatus may be an ultrasound diagnostic device 1000. FIG. 8 is a block diagram of a configuration of the ultrasound diagnostic device 1000 according to an exemplary embodiment of the present invention. The ultrasound diagnostic device 1000 according to the present embodiment includes a probe 20, an ultrasound transmission/reception unit 100, an image processing unit 200, a communication unit 300, a memory 400, an input device 500, and a controller 600, and the components may be connected to one another via buses 700. FIG. 8 is used for describing some embodiments, and the medical imaging apparatus may have other configurations than that illustrated in FIG. 8 according to embodiments of the present invention.

The ultrasound diagnostic device 1000 may be embodied not only as a cart type device but also as a portable type. Examples of portable ultrasound diagnostic devices may include a Picture Archiving and Communications System (PACS) viewer, a smartphone, a laptop computer, a personal digital assistant (PDA), and a tablet PC. However, the present invention is not limited thereto.

The probe 20 transmits ultrasound signals to an object 10, based on a driving signal applied by the ultrasound transmission/reception unit 100, and receives echo signals reflected from the object 10. The probe 20 includes a plurality of transducers that oscillate based on electric signals transmitted thereto and generate acoustic energy, that is, ultrasound waves. Furthermore, the probe 20 may be connected to a main body of the ultrasound diagnostic device 1000 by wires or wirelessly. According to embodiments of the present invention, the ultrasound diagnostic device 1000 may include a plurality of probes 20.

A transmission unit 110 supplies a driving signal to the probe 20 and includes a pulse generating unit 112, a transmission delaying unit 114, and a pulser 116. The pulse generating unit 112 generates pulses for forming transmission ultrasound waves based on a predetermined pulse repetition frequency (PRF), and the transmission delaying unit 114 applies a delay time for determining transmission directionality to the pulses. Pulses, to which a delay time is applied, correspond to a plurality of piezoelectric vibrators included in the probe 20, respectively. The pulser 116 applies a driving signal (or a driving pulse) to the probe 20 at a timing corresponding to each pulse to which a delay time is applied.

A reception unit 120 generates ultrasound data by processing echo signals received from the probe 20. The reception unit 120 may include an amplifier 122, an analog-to-digital converter (ADC) 124, a reception delaying unit 126, and a summing unit 128. The amplifier 122 amplifies echo signals in each channel, and the ADC 124 performs analog-to-digital conversion on the amplified echo signals. The reception delaying unit 126 applies delay times for determining reception directionality to the conversed echo signals, and the summing unit 128 generates ultrasound data by summing the echo signals processed by the reception delaying unit 126. According to embodiments of the present invention, the reception unit 120 may not include the amplifier 122. In other words, if the sensitivity of the probe 20 or the capability of the ADC 124 to process bits is enhanced, the amplifier 122 may be omitted.

The image processing unit 200 generates an ultrasound image by scan-converting ultrasound data generated by the ultrasound transmission/reception unit 100 and displays the ultrasound image. In addition, an ultrasound image may include not only a gray-scale ultrasound image obtained by scanning an object in an amplitude (A) mode, a B mode, and a motion (M) mode, but also a Doppler image representing a moving object by using a Doppler effect. The Doppler image may include a blood flow Doppler image (also called a color Doppler image) showing a flow of blood, a tissue Doppler image showing movement of tissue, and a spectral Doppler image showing a moving speed of an object as a waveform.

A B mode processing unit 212 extracts B mode components from ultrasound data and processes the B mode components. An image generating unit 220 may generate an ultrasound image indicating signal intensities as brightness based on the extracted B mode components.

Similarly, a Doppler processing unit 214 may extract Doppler components from ultrasound data, and the image generating unit 220 may generate a Doppler image indicating movement of an object as colors or waveforms based on the extracted Doppler components.

The image generating unit 220 according to an embodiment of the present invention may generate a three-dimensional (3D) ultrasound image via volume-rendering of volume data and an elasticity image which shows the degree of deformation of the object 10 due to pressure. Furthermore, the image generating unit 220 may display additional information in an ultrasound image by using text and graphics. In addition, the generated ultrasound image may be stored in the memory 400.

A display unit 230 displays and outputs the generated ultrasound image. The display unit 230 may display and output not only an ultrasound image but also various information processed by the ultrasound diagnostic device 1000 on a screen via a graphical user interface (GUI). In addition, the ultrasound diagnostic device 1000 may include two or more display units 230 according to embodiments of the present invention.

The communication unit 300 is connected to a network 30 by wires or wirelessly and communicates with external devices or servers. The communication unit 300 may exchange data with a hospital server or another medical device in a hospital that is connected via a Picture Archiving and Communications System (PACS). Furthermore, the communication unit 300 may perform data communication according to the Digital Imaging and Communications in Medicine (DICOM) standard.

The communication unit 300 may transmit or receive data to or from the external device (1100 in FIG. 1). The communication unit 300 may transmit or receive data related to diagnosis of the object 10, e. g., an ultrasound image, ultrasound data, and Doppler data of the object 10, via the network 30. The communication unit 300 may also transmit or receive medical images obtained by other medical devices, such as a CT image, an MR image, and an X-ray image. Furthermore, the communication unit 300 may receive information related to a diagnosis history or a treatment schedule of a patient from a server and utilizes the information for diagnosing the patient, i.e., the object 10. Furthermore, the communication unit 300 may perform data communication with a server or a medical device in a hospital as well as a portable terminal of a doctor or a patient.

The communication unit 300 is connected to the network 30 in a wired or wireless manner and may exchange data with the external device 1100 such as a server 32, a medical device 34, or a portable terminal 36. The communication unit 300 may include at least one component that enables communication with the external device 1100, e. g., a local area communication module 310, a wired communication module 320, and a mobile communication module 330.

The local area communication module 310 is a module for performing local area communication with a device that is within a predetermined distance. Examples of local area communication technology include a wireless Local Area Network (LAN), Wi-Fi, Bluetooth, ZigBee, Wi-Fi Direct (WFD), Ultra Wideband (UWB), Infrared Data Association (IrDA), Bluetooth Low Energy (BLE), and Near Field Communication (NFC), but are not limited thereto.

The wired communication module 320 is a module for performing communication by using an electric signal or an optical signal. Examples of wired communication technology include wired communication technologies using a pair cable, a coaxial cable, an optical fiber cable, and an Ethernet cable OK.

The mobile communication module 330 transmits or receives wireless signals to or from at least one of a base station, an external terminal, and a server on a mobile communication network. Here, the wireless signals may include voice call signals, video call signals, or various types of data for transmission and reception of text/multimedia messages.

The memory 400 stores various data processed by the ultrasound diagnostic device 1000. For example, the memory 400 may store not only medical data related to the diagnosis of the object 10, such as ultrasound data and ultrasound images that are input or output, but also algorithms or programs that are executed in the ultrasound diagnostic device 1000.

The memory 400 may be embodied as any of various storage media such as a flash memory, a hard disk drive, and Electrically Erasable Programmable Read-Only Memory (EEPROM). Furthermore, the ultrasound diagnostic device 1000 may utilize a web storage or a cloud server that functions as the memory 400 online.

The input device 500 is a means via which a user inputs data for controlling the ultrasound diagnostic device 1000. The input device 500 may include hardware components, such as a keypad, a mouse, a touch panel, a touch screen, a trackball, and a jog switch. However, the present invention is not limited thereto, and the input device 500 may further include various other input elements such as an electrocardiogram measuring module, a respiration measuring module, a voice recognition sensor, a gesture recognition sensor, a fingerprint recognition sensor, an iris recognition sensor, a depth sensor, a distance sensor, etc.

The controller 600 may control overall operations of the ultrasound diagnostic device 1000. In other words, the controller 600 may control operations among the probe 20, the ultrasound transmission/reception unit 100, the image processing unit 200, the communication unit 300, the memory 400, and the input device 500.

All or some of the probe 20, the ultrasound transmission/reception unit 100, the image processing unit 200, the communication unit 300, the memory 400, the input device 500, and the controller 600 may be operated by software modules. However, the present invention is not limited thereto, and some of the above components may be operated by hardware modules. Furthermore, at least one of the ultrasound transmission/reception unit 100, the image processing unit 200, and the communication unit 300 may be included in the controller 600, but are not limited thereto.

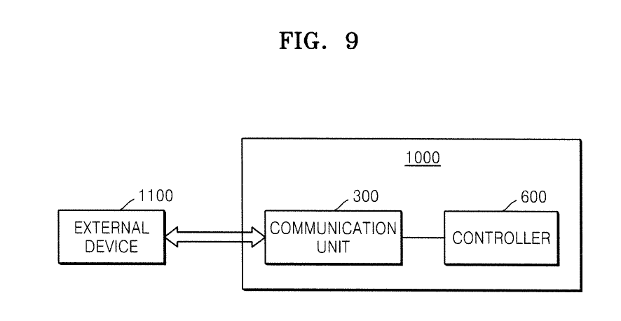

FIG. 9 is a schematic diagram of a configuration of a medical imaging apparatus 1000 according to an exemplary embodiment of the present invention. The medical imaging apparatus 1000 according to the present embodiment may include a communication unit 300 and a controller 600.

The communication unit 300 may communicate with an external device 1100. When a request for a guide is received from the external device 1100 through the communication unit 300, the controller 600 may determine guide information corresponding to the request for the guide. In one embodiment, the controller 600 may determine guide information according to an operation state of the medical imaging apparatus 1000 at the time when the request for the guide is received.

According to some embodiments, the controller 600 may perform image recognition on a screen being displayed on the display unit (230 in FIG. 8) in order to determine an operation state of the medical imaging apparatus 1000. The controller 600 may determine the operation state of the medical imaging apparatus 1000 based on the result of the image recognition. As described above with reference to FIG. 4, the operation state of the medical imaging apparatus 1000 may be determined by using the result of the image recognition. Furthermore, in some embodiments, the controller 600 may retrieve a document related to an operation state of the operation state of the medical imaging apparatus 1000. In this case, the controller 600 may generate guide information containing information about a retrieved document, based on the retrieval result.

The controller 600 may control the communication unit 300 to transmit the determined guide information to the external device 1100. In one embodiment, the guide information transmitted to the external device 1100 may include ID information necessary for distinguishing the guide information. The ID information may be address information indicating a location of the guide information.

Some of the above-described operations of the controller 600 may be performed by the image processing unit 200 of FIG. 8 as well. For example, the image processing unit 200 may perform image recognition on a screen of the display unit 230. However, the present invention is not limited thereto, and the image processing unit 200 and the controller 600 may be implemented as a single hardware device, or one of the image processing unit 200 and the controller 600 may perform some of the functions of the other component, according to embodiments of the present invention.

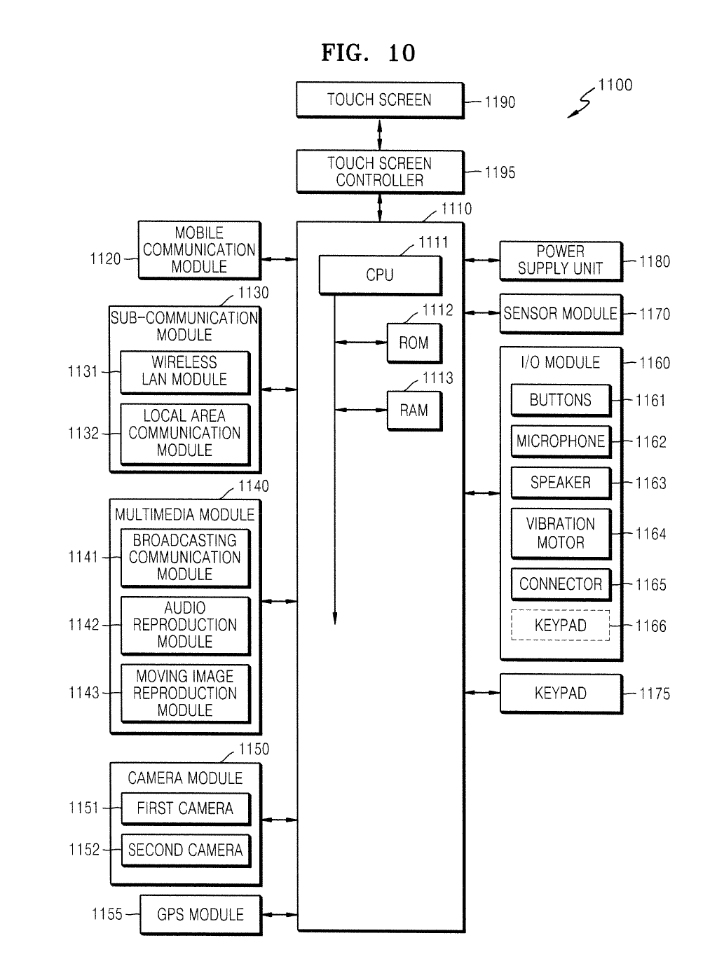

FIG. 10 is a block diagram of a configuration of an external device 1100 according to an exemplary embodiment of the present invention. FIG. 10 is provided for describing an embodiment of the present invention only, and the external device 1100 is not limited to the configuration illustrated in FIG. 10. The external device 1100 may include more or fewer components than illustrated in FIG. 10, or other components may be used instead of those illustrated in FIG. 10.

The external device 1100 may be connected to another device (not shown) by using a mobile communication module 1120, a sub-communication module 1130, and a connector 1165. The other device may include at least one of the medical imaging apparatus (1000 in FIG. 8), a mobile phone (not shown), a smartphone (not shown), a tablet PC (not shown), and a server (not shown).

Referring to FIG. 10, the external device 1100 according to the present embodiment includes a touch screen 1190 and a touch screen controller 1195. The external device 1100 may further include a controller 1110, a mobile communication module 1120, a sub-communication module 1130, a multimedia module 1140, a camera module 1150, a Global Positioning System (GPS) module 1155, an input/output (I/O) module 1160, a sensor module 1170, a storage unit 1175, and a power supply unit 1180. The sub-communication module 1130 may include at least one of a wireless local area network (LAN) module 1131 and a local area communication module 1132. The multimedia module 1140 may include at least one of a broadcasting communication module 1141, an audio reproduction module 1142, and a moving image reproduction module 1143. The camera module 1150 includes at least one of a first camera 1151 and a second camera 1152. The I/O module 1160 includes at least one of buttons 1161, a microphone 1162, a speaker 1163, a vibration motor 1164, the connector 1165, and a keypad 1166.

The controller 1110 may include a Central Processing Unit (CPU) 1111, Read Only Memory (ROM) 1112 which stores a control program for controlling the external device 1100, and Random Access Memory (RAM) 1113 which stores a signal or data received from the outside of the external device 1100, or which is used as a memory area for a task performed by the external device 1100. The CPU 1111 may include a plurality of processors such as a single-core processor, a dual-core processor, a triple-core processor, a quad-core processor, or the like. The CPU 1111, the ROM 1112 and the RAM 1113 may be interconnected via an internal bus.

The controller 1110 may control the mobile communication module 1120, the sub-communication module 1130, the multimedia module 1140, the camera module 1150, the GPS module 1155, the I/O module 1160, the sensor module 1170, the storage unit 1175, the power supply unit 1180, a first touch screen 1190a, a second touch screen 1190b, and a touch screen controller 1195.

The mobile communication module 1120 is controlled by the controller 1110 to allow the external device 1100 to be connected to another device via mobile communication by using at least one (one or more) antenna (not shown). The mobile communication module 1120 may transmit or receive a wireless signal for a voice call, a video call, a Short Message Service (SMS), a Multimedia Messaging Service (MMS), or the like to/from a mobile phone (not shown), a smartphone (not shown), a tablet PC (not shown), or another device (not shown), which has a telephone number that is input to the external device 1100.

As described above, the sub-communication module 1130 may include at least one of the wireless LAN module 1131 and the local area communication module 1132. For example, the sub-communication module 1130 may include only the wireless LAN module 1131, only the local area communication module 1132, or both of them.

The wireless LAN module 1131 is controlled by the controller 1110 to connect to the Internet at a place where a wireless access point (AP; not shown) is installed. The wireless LAN module 1131 supports the IEEE802.11x wireless LAN standard developed by Institute of Electrical and Electronics Engineers (IEEE). The local area communication module 1132 is controlled by the controller 1110 to enable the external device 1100 to perform wireless local area communication with another medical device. Local area communication technologies may include Bluetooth, IrDA, ZigBee, etc.

The external device 1100 may include at least one of the mobile communication module 1120, the wireless LAN module 1131, and the local area communication module 1132 according to performance thereof.

The multimedia module 1140 may include the broadcasting communication module 1141, the audio reproduction module 1142, or a moving image reproduction module 1143. The broadcasting communication module 1141 may be controlled to receive a broadcast signal (e.g., a TV broadcast signal, a radio broadcast signal, or a data broadcast signal) and broadcast additional information (e.g., an Electronic Program Guide (EPS) or an Electronic Service Guide (ESG)), which is transmitted by a broadcast station through a broadcast communication antenna (not shown). According to control of the controller 1110, the audio reproduction module 1142 may reproduce a stored or received digital audio file. According to control of the controller 1110, the moving image reproduction module 1143 may reproduce a stored or received digital moving image file. The moving image reproduction module 1143 may reproduce a digital audio file.

The multimedia module 1140 may include the audio reproduction module 1142 and the moving image reproduction module 1143, except for the broadcasting communication module 1141. Furthermore, the audio reproduction module 1142 or the moving image reproduction module 1143 of the multimedia module 1140 may be included in the controller 1110.

The camera module 1150 may include at least one of the first and second cameras 1151 and 1152 that capture a still image or moving image according to control of the controller 1110. The first or the second camera 1151 or 1152 may include an auxiliary light source (not shown) that provides light required to capture an image. The first and second cameras 1151 and 1152 may be mounted on front and rear surfaces of the external device 1100, respectively. Alternatively, the first and second cameras 1151 and 1152 may be disposed adjacent to each other (e.g., a distance between the first and second cameras 1151 and 1152 is greater than 1 cm and is less than 8 cm), and capture a 3D still image or 3D moving image.

The GPS module 1155 receives radio waves from a plurality of GPS satellites (not shown) in the Earth orbit, and the GPS module 1155 may calculate a location of the external device 1100 by using a Time of Arrival (TOA) from each of the GPS satellites to the external device 1100.

The I/O module 1160 may include at least one of a plurality of buttons 1161, the microphone 1162, the speaker 1163, the vibration motor 1164, the connector 1165, and the keypad 1166.

The buttons 1161 may be formed on a front surface, a lateral surface, or a rear surface of a housing of the external device 1100, and may include at least one of a power/lock button (not shown), a volume button (not shown), a menu button (not shown), a home button (not shown), a back button (not shown), and a search button (not shown).

According to control of the controller 1110, the microphone 1162 may receive a voice or sound as input and generate an electrical signal.

According to control of the controller 1110, the speaker 1163 may output sounds corresponding to various signals from the mobile communication module 1120, the sub-communication module 1130, the multimedia module 1140, or the camera module 1150, to the outside of the external device 1100. The speaker 1163 may output a sound corresponding to a function that is performed by the external device 1100. The external device 1100 may include multiple speakers. The speaker 1163 or a plurality of speakers may be disposed at an appropriate position or appropriate positions of the housing of the external device 1100.

According to control of the controller 1110, the vibration motor 1164 may convert an electrical signal into a mechanical vibration. For example, when the external device 1100 in a vibration mode receives a voice call from another device (not shown), the vibration motor 1164 may operate. The vibration motor 1164 may operate in response to a user's touch action on the touch screen 1190 and a continuous movement of a touch input on the touch screen 1190.

The connector 1165 may be used as an interface for connecting the external device 1100 with another device (not shown) or a power source (not shown). According to control of the controller 1110, the external device 1100 may transmit data stored in the storage unit 1175 of the external device 1100 to the other device or receive data from the other device through a wired cable connected to the connector 1165. The external device 1100 may also receive power from the power source or charge a battery (not shown) via the wired cable.

The keypad 1166 may receive a key input from the user in order to control the external device 1100. The keypad 1166 includes a physical keypad (not shown) installed on the front surface of the external device 1100 or a virtual keypad (not shown) displayed on the touch screen 1190. The keypad 1166 may not include the physical keypad according to the performance or structure of the external device 1100.

The sensor module 1170 includes at least one sensor for detecting the state of the external device 1100. For example, the sensor module 170 may include a proximity sensor for detecting whether the user is close to the external device 1100, an illuminance sensor (not shown) for detecting the amount of light around the external device 1100, or a motion sensor (not shown) for detecting a motion of the external device 1100 (e.g., rotation of the external device 1100 or acceleration or vibration applied to the external device 1100). Sensors may be added to or removed from the sensor module 1170 according to the performance of the external device 1100.

According to control of the controller 1110, the storage unit 1175 may store a signal or data which is input/output in response to an operation of each of the mobile communication module 1120, the sub-communication module 1130, the multimedia module 1140, the camera module 1150, the GPS module 1155, the I/O module 1160, the sensor module 1170, and the touch screen 1190. The storage unit 1175 may store applications and control programs for controlling the external device 1100 or the controller 1110.

The term “storage unit” includes the storage unit 1175, the ROM 1112 and the RAM 1113 within the controller 1110, or a memory card (not shown) mounted in the external device 1100. The storage unit may include a non-volatile memory, a volatile memory, a Hard Disk Drive (HDD), or a Solid State Drive (SSD).

According to control of the controller 1110, the power supply unit 1180 may supply power to at least one battery (not shown) disposed in the housing of the external device 1100. The power supply unit 1180 may also supply power provided by an external power source (not shown) to each component in the external device 1100 through a wired cable connected to the connector 1165.

The touch screen 1190 may output a user interface corresponding to various services to the user. The touch screen 1190 may transmit an analog signal corresponding to at least one touch which is input to the user interface to the touch screen controller 1195. The touch screen 1190 may also receive at least one touch input through the user's body such as fingers or an input means enabling a touch, such as a stylus pen. Furthermore, the touch screen 1190 may receive a continuous movement of at least one touch input. The touch screen 1190 may then transmit an analog signal corresponding to the continuous movement of the touch input to the touch screen controller 1195.

According to exemplary embodiments of the present invention, a touch input is not limited to an input through a touch of the user's body or an input means enabling a touch, on the touch screen 1190, but may include a non-contact touch (e.g., where a distance between the touch screen 1190 and the user's body or the input means enabling a touch is less than or equal to 1 mm). A detectable distance in the touch screen 1190 may vary depending on the performance or structure of the external device 1100.

For example, the touch screen 1190 may be implemented as a resistive touch screen, a capacitive touch screen, an infrared touch screen, or an ultrasound wave touch screen.

The touch screen controller 1195 may convert an analog signal received from the touch screen 1190 into a digital signal (e.g., X and Y coordinates), and transmit the digital signal to the controller 1110. The controller 1110 may control the touch screen 1190 by using the digital signal received from the touch screen controller 1195. For example, in response to a touch input, the controller 1110 may select an application execution icon (not shown) displayed on the touch screen 1190 or execute an application. The touch screen controller 1195 may be included in the touch screen 1190 or the controller 1110.

Exemplary embodiments of the present invention may be implemented through computer-readable recording media having recorded thereon computer-executable instructions such as program modules that are executed by a computer. Computer-readable recording media may be any available media that can be accessed by a computer and include both volatile and nonvolatile media and both detachable and non-detachable media. Furthermore, the computer-readable media may include computer storage media and communication media. The computer storage media include both volatile and nonvolatile and both detachable and non-detachable media implemented by any method or technique for storing information such as computer-readable instructions, data structures, program modules or other data. The communication media typically embody computer-readable instructions, data structures, program modules, other data of a modulated data signal, or other transmission mechanism, and they include any information transmission media.

While one or more embodiments of the present invention have been described with reference to the figures, it will be understood by those of ordinary skill in the art that various changes in form and details may be made therein without departing from the spirit and essential characteristics of the present invention as defined by the following claims. Thus, it should be understood that the exemplary embodiments described therein should be considered in a descriptive sense only and not for purposes of limitation. For example, components described as a single piece may be implemented in a distributed fashion, and similarly components described as being distributed may be implemented in a combined form.

Therefore, the scope of the invention is defined not by the embodiments but by the appended claims, and all modifications or variations within the scope of the appended claims and their equivalents will be construed as being included in the present invention.

1. A method of providing guide information in a medical imaging system including a medical imaging apparatus and an external device, the method comprising:
transmitting, by the external device, a request for a guide to the medical imaging apparatus;
determining, by the medical imaging apparatus, guide information corresponding to the request for the guide;
transmitting, by the medical imaging apparatus, the determined guide information to the external device; and
displaying the guide information by the external device.

2. The method of claim 1, wherein in the determining of the guide information, the medical imaging apparatus determines the guide information according to an operation state thereof.

3. The method of claim 2, wherein the determining of the guide information further comprises:
performing image recognition on a screen displayed on the medical imaging apparatus, wherein the performing is performed by the medical imaging apparatus; and
determining the operation state based on the result of the image recognition, wherein the determining is performed by the medical imaging apparatus.

4. The method of claim 2, wherein the operation state comprises an operation mode of the medical imaging apparatus.

5. The method of claim 2, wherein the guide information comprises a reference medical image corresponding to the operation state.

6. The method of claim 2, wherein the determining of the guide information comprises:
retrieving, by the medical imaging apparatus, a document related to the operation state; and
determining, by the medical imaging apparatus, the guide information containing information related to the retrieved document.

7. The method of claim 1, wherein the medical imaging apparatus and the external device communicate with each other by using short-range wireless communication.

8. The method of claim 1, wherein the guide information comprises address information, and
wherein the displaying of the guide information comprises:
receiving data by the external device, based on the address information; and
displaying, by the external device, the received data.

9. A method of providing guide information in a medical imaging apparatus, the method comprising:
receiving a request for a guide from an external device;
determining guide information corresponding to the request for the guide; and
transmitting the determined guide information to the external device.

10. The method of claim 9, wherein in the determining of the guide information, the guide information is determined according to an operation state of the medical imaging apparatus.

11. The method of claim 10, wherein the determining of the guide information further comprises:
performing image recognition on a screen displayed on the medical imaging apparatus; and
determining the operation state based on the result of the image recognition.

12. The method of claim 10, wherein the operation state comprises an operation mode of the medical imaging apparatus.

13. The method of claim 10, wherein the guide information comprises a reference medical image corresponding to the operation state.

14. The method of claim 10, wherein the determining of the guide information comprises:
retrieving a document related to the operation state; and
determining the guide information containing information related to the retrieved document.

15. The method of claim 9, wherein the medical imaging apparatus communicates with the external device by using short-range wireless communication.

16. The method of claim 9, wherein the guide information comprises address information necessary for receiving data.

17. A medical imaging apparatus comprising:
a communication unit that performs communication with an external device; and
a controller that, upon receipt of a request for a guide from the external device, determines guide information corresponding to the request for the guide, and controls the operation of the communication unit so that the determined guide information is transmitted to the external device through the communication unit.

18. The apparatus of claim 17, wherein the controller determines the guide information according to an operation state of the medical imaging apparatus.

19. The apparatus of claim 18, wherein the controller performs image recognition on a screen displayed on the medical imaging apparatus and determines the operation state based on the result of the image recognition.

20. The apparatus of claim 18, wherein the operation state comprises an operation mode of the medical imaging apparatus.

21. The apparatus of claim 18, wherein the guide information comprises a reference medical image corresponding to the operation state.

22. The apparatus of claim 18, wherein the controller retrieves a document related to the operation state, and
wherein the guide information includes information related to the retrieved document.

23. The apparatus of claim 17, wherein the communication unit performs communication with the external device by using wireless local area communication.

24. The apparatus of claim 17, wherein the guide information includes address information necessary for receiving data.

25. A medical imaging system comprising:
a medical imaging apparatus that receives a request for a guide from an external device, determines guide information corresponding to the received request for the guide, and transmits the guide information to the external device; and
the external device that transmits the request for the guide to the medical imaging apparatus and displays the guide information received from the medical imaging apparatus.

26. A non-transitory computer-readable recording medium having recorded thereon a program for executing the methods of claim 1 on a computer.
